(19) United States
(12) Patent Application Publication
(10) Pub. No.: US 2010/0106715 A1
(43) Pub. Date: Apr. 29, 2010

(54) METHOD AND SYSTEM FOR OFFERING BANNER ADVERTISING WITH INDEX FUNCTION, AND COMPUTER READABLE MEDIA FOR RECORDING THE ADVERTISING METHOD PROGRAM

(75) Inventors: Eun Ja Byun, Kyunggi-do (KR); Youn Kook Jeon, Kyunggi-do (KR)

Correspondence Address: H.C. PARK & ASSOCIATES, PLC, 8500 LEESBURG PIKE, SUITE 7500, VIENNA, VA, 22182, US

(73) Assignee: NHN CORPORATION, Kyunggi-do (KR)

(21) Appl. No.: 12/519,153

(22) PCT Filed: Nov. 27, 2007
(86) PCT No.: PCT/KR07/06016

§ 371 Date: Jun. 12, 2009

(30) Foreign Application Priority Data
Dec. 14, 2006 (KR) 10-2006-0128057

(51) Int. Cl. G06F 17/30

(52) U.S. Cl. 707/722; 707/E17.141

(57) ABSTRACT

Disclosed is a method for offering banner advertisement with a search function. The method for offering banner advertisement with the search function includes loading a search input window with a search function, and exposing the loaded search input window to a banner advertising window including banner advertisement.

### TECHNICAL FIELD

The present invention relates to a method and a system for offering banner advertisement with a search function, and more particularly, to a method and a system for offering banner advertisement with a search function in which the banner advertisement is connected with a search input window, thereby embodying banner advertisement function and search function.

### BACKGROUND ART

Currently, the Internet is widely used as a part of everyday life, and thus demands for advertising via an Internet site remarkably increase. The Internet site has an advantage in that advertising via the Internet site can be viewed by a greater number of users due to characteristics of the Internet being intended for unspecified individuals in comparison with off-line advertising.

In various advertising types via the Internet site, banner type advertising is mainly used. The banner type advertising denotes advertising displayed on a specific part of Internet web pages and designed by a company wishing to advertise with graphical images. The banner advertising is derived from a banner, and performed such that moving picture files and the like with a predetermined size are viewed on the Internet web pages and a predetermined advertising rate for the advertising is paid. The banner advertising may be referred to as display advertising (DA).

In order to analyze advertising effects, the banner advertising may calculate a number of exposures of the banner advertising and a number of times graphical images of the banner advertising are downloaded in a predetermined time period, and thus providing the analyzed advertising effects to advertisers.

When the banner advertising first began, the banner advertising was a simple form of a rectangular-shape advertising domains or businesses, however, has diversely developed into forms such as using moving pictures, fixedly placing on a screen of the web site, and the like.

These banner advertising is generally commercialized as a form of a Cost Per Mill (CPM). The CPM denotes an advertising flat rate, which is paid for advertisement exposures of 1,000 times. In this regard, when it is assumed that CPM is 100 won, the advertising rate paid for the advertisement exposures of 1,000 times is 100 won. This is calculated based on an advertising rate of a banner advertisement displayed on a top or bottom portion of the first page of a general web page. Mill denotes 1,000 in Roman numerals.

However, the above-described conventional banner advertising merely performs an advertising function. In this regard, there arises a problem in that the banner advertising which fails to attract attentions of viewers with respect to advertising contents exposed on a banner window is not considered as an effective advertising means. Also, when the Internet site providing the banner advertising is used, many web surfers regard theses banner advertising as highly annoying because they distract from his or her desired contents. When the banner advertising is provided without attracting attention, which makes it annoying, it would provide no revenue for the advertiser or for the advertising provider.

Currently, many portal sites provide various types of search services, and a great number of people retrieve desired information using the search services. Thus, there is high need for banner advertising which simultaneously performs the advertising function and the search function by adapting the search service function to the banner advertising, thereby improving advertising effect.

### DISCLOSURE OF INVENTION

### Technical Goals

An aspect of the present invention provides a method for offering banner advertisement with a search function in which the banner advertisement and a search input window are connected with each other, thereby simultaneously embodying a banner advertisement function and a search function.

Another aspect of the present invention provides a system for offering banner advertisement with a search function which includes the above-described search function.

### Technical Solutions

According to an aspect of the present invention, there is provided a method for offering banner advertisement with a search function which includes loading a search input window with a search function; and exposing the loaded search input window to a banner advertising window including banner advertisement.

In this instance, the loading may load a User Interface (UI) of a search site providing the search function in the banner advertising window.

Also, the loading may provide a keyword associated with the banner advertisement as a default value in the search input window.

The method for offering the banner advertisement according to an exemplary embodiment of the invention may further include summing a number of exposures of the banner advertisement in a log; and providing the summed number of exposures of the banner advertisement in the log in a form of a report.

In this instance, the method for offering the banner advertisement may further include encoding a keyword inputted in the search input window and transmitting the encoded keyword, when a search for the inputted keyword is performed; retrieving information associated with the keyword in a search database; and exposing results retrieved in the search database.

In this instance, the banner advertisement may include a flash banner advertisement, and the keyword inputted in the search input window may be encoded within the flash banner advertisement.

Also, the exposing may be performed in a site providing the banner advertisement.

Also, the exposing may be performed in the search site providing the search function.

The method for offering the banner advertisement may further include summing a number of times of the search execution in a log; and providing the summed number of times of the search execution in the log.

The method for offering the banner advertisement may further include exposing an advertiser's site associated with the banner advertisement when the banner advertisement is clicked on; summing a number of clicks of the banner advertisement in a log; and providing the summed number of clicks of the banner advertisement in the log.

In this instance, a default advertisement may be exposed in the banner advertising window when exposure of advertisement guaranteed in the banner advertising window does not occur.

According to another aspect of the present invention, there is provided a system for offering banner advertisement with a search function, which includes an advertisement exposure server linked with the banner advertisement with the search function. In this instance, the advertisement exposure server may include: a load unit for loading a search input window with the search function; and a banner advertisement exposure unit for exposing the loaded search input window in a banner advertising window including the banner advertisement.

Also, the load unit may load the UI of a search site providing the search function in the banner advertising window.

Also, the load unit may provide a keyword associated with the banner advertisement as a default value in the search input window.

Also, the banner advertisement exposure unit may further include a keyword transmission unit for encoding a keyword inputted in the search input window and transmitting the encoded keyword, when a search for the inputted keyword is executed; an information retrieval unit for retrieving information associated with the keyword in a search database; and an information exposure unit for exposing results retrieved in the search database.

Also, the banner advertisement may include a flash banner advertisement, and the keyword is encoded within the flash banner advertisement.

Also, the advertisement exposure server may further include a site exposure unit for exposing an advertiser's site of the banner advertisement when the banner advertisement is clicked on.

Also, the advertisement exposure server may further include a summation unit for summing the number of exposures of the banner advertisement, the number of times of the search execution, and the number of clicks of the banner advertisement in a log, respectively; and a report providing unit for providing the summed number of exposures of the banner advertisement, the number of times of the search execution, and the number of clicks of the banner advertisement summed in the log, respectively.

Advantages and features of the present invention and a method for realizing the advantages and features thereof will be become more apparent with reference to exemplary embodiments and accompanying drawings which will be described in detail below. However, the present invention is not limited to the exemplary embodiments which will be described below, and may be embodied as various types thereof. Instead, it would be appreciated by those skilled in the art that changes may be made to these embodiments without departing from the principles and spirit of the invention, the scope of which is defined by the claims and their equivalents. Identical numerals in the drawings represent similar parts throughout the description.

FIG. 1 is a flowchart illustrating a method for offering banner advertisement with a search function according to an exemplary embodiment of the present invention. Referring to FIG. 1, in operation S101, a banner advertisement 210 is first created in order to provide a banner advertisement window 200 on a site. In this instance, the banner advertisement 210 may include a flash animation. The flash animation denotes a computer animation made by using software flash developed by Macromedia Ltd, of the US for creating moving pictures and may be created mainly with lines. A file size of the flash animation is merely 1/16 of a general moving picture and thus there are several advantages in that the transmission rate is relatively faster, the image is not broken, and the creating method thereof is simple.

Next, when a user connects with a site for providing the banner advertisement 210 via a computer and the like, the search input window 220 with the search function is loaded to the banner advertisement window 200 providing the banner advertisement 210 in operation S102. In this instance, the search input window 220 is preferably provided such that a User Interface (UI) of a search site providing a search function is loaded to the banner advertisement window 200.

In the above-described search input window 220, keywords associated with the banner advertisement 210 may be provided as default keywords and exposed. In this instance, the keywords associated with the banner advertisement 210 are not provided as the default keywords in the search input window 220, and keywords unassociated with the banner advertisement 210 may be provided and exposed. Also, keywords including default keywords are not provided in the search input window 220, so that any keywords cannot be exposed through the search input window 220.

Next, in operation S103, the banner advertisement 210 is uploaded in the banner advertisement window 200 using an advertisement template registered in an advertisement database. In this instance, when guaranteed advertisement exists in the banner advertisement window 200, the guaranteed advertisement may be uploaded, and when the guaranteed advertisement does not exist, default advertisement may be uploaded. The default advertisement may be advertisement associated with a company providing the banner advertisement 210 with the search function according to the present exemplary embodiment of the invention.

Next, in operation S104, the banner advertisement 210 is exposed in the banner advertisement window 200, and a number of the exposures is summed in a log. Specifically, every time the banner advertisement 210 is exposed, a number of exposures of the banner advertisement 210 having been summed is increased by 1 to thereby sum the number of exposures of the banner advertisement 210 in the log.

Next, when a user clicks on the banner advertisement 210 in the banner advertisement window 200, which is connected with the search input window 220 and the banner advertisement 210, using a mouse pointer, and activates the banner advertisement 210 in operation S105, a number of clicks of the banner advertisement 210 is summed in a log in operation S106, and then the banner advertisement 210 moves the user to an advertiser's site to thereby expose the advertiser's site in operation S107. In this instance, to activate the banner advertisement 210, the banner advertisement 210 may be activated by clicking on the banner advertisement 210 using the mouse pointer, however, the present invention is not limited thereto. Specifically, the banner advertisement 210 may be activated merely by placing the mouse pointer on the banner advertisement 210 for a predetermined time interval.

Here, when the banner advertisement 210 sums the number of clicks using the mouse pointer in the log, every time the user clicks on the banner advertisement 210, the number of clicks of the banner advertisement 210, that is, a number of times the banner advertisement 210 is activated, may be summed by increasing the log count by 1.

Also, when the banner advertisement 210 is activated by placing the mouse pointer on the banner advertisement 210 for a predetermined time interval, a number of times the mouse pointer is placed on the banner advertisement 210 for the predetermined time interval may be summed in the log. Specifically, when the mouse pointer is placed on the banner advertisement 210 for the predetermined time interval, every time the user places the mouse pointer on the banner advertisement 210 for the predetermined time interval, a number of times the mouse pointer is placed on the banner advertisement 210 for the predetermined time interval, that is, a number of times the banner advertisement 210 is activated, may be summed by increasing the log count by 1.

Also, when the user inputs a keyword in the search input window 220 to perform a search in operation S108, the inputted keyword in the search input window 220 is encoded in operation S109, and the encoded keyword is transmitted to a search server in operation S110. In this instance, the inputted keyword may be encoded within the flash animation in an exemplary embodiment of the banner advertisement 210, and then the encoded keyword is transmitted to the search server. Alternatively, the inputted keyword may be encoded by a separate device, and then the encoded keyword is transmitted to the search server. Here, as described above, the keyword associated with the banner advertisement 210 may be provided as a default keyword to thereby be exposed. Also, the search server may be any one of a site providing the banner advertisement 210, a search site, and a site providing the banner advertisement 210 while performing a search.

Next, in operation S111, a number of times a search is performed through the search input window 220 is summed in a log, and the summed number may be reflected in a number of search queries through a search system providing the search site. Specifically, the number of times the search is performed through the search input window 220 and the number of search queries through the search system may be added together and reflected in the number of search queries through the search system.

For example, when a search is performed through the search input window 220 using ‘NAVER’ as a keyword, a number of times a search is performed with respect to ‘NAVER’ through the search input window 220 and a number of search queries of the search system with respect to ‘NAVER’ are added together, and reflected in the search system. In this manner, the search system may calculate the number of search queries with respect to ‘NAVER’ based on the reflected number in the search system.

Next, in operation S112, the search server exposes, in the search site or the site providing the banner advertisement, information associated with the keyword inputted through the search input window 220. In this instance, the search server exposes the information associated with the keyword according to the priority order of the information in such a manner that information perfectly corresponding to the keyword may be exposed as the top priority.

However, when the information perfectly corresponding to the keyword inputted through the search input window 220 does not exist, the search server may expose information being most associated with the keyword as the top priority. Also, when a search is performed in a state where a keyword is not inputted in the search input window 220, a web page including a message indicating the retrieval result does not exist may be exposed either via the search site or the site providing the banner advertisement.

As described above, the search server may be any one of the search site, the site providing the banner advertisement, and the site providing the banner advertisement while performing a search.

FIG. 2 is a diagram illustrating an example of a retrieval result screen acquired by performing a search via a search input window in the method for offering banner advertisement with a search function according to an exemplary embodiment of the present invention.

Referring to FIG. 2, the banner advertisement 210 and the search input window 220 are connected with each other and embodied in the banner advertisement window 200. When a keyword is inputted in the search input window 220 of the banner advertisement window 200 and a search execution button 222 is clicked on by a mouse pointer, information associated with the keyword inputted in the search input window 220 is exposed via a web page 230 of the search site.

Here, when a keyword of ‘HYUNDAI CARD’ is inputted in the search input window 220 and then the search execution button 222 is clicked on by a user, information associated with ‘HYUNDAI CARD’ is exposed via the search site or the site providing the banner advertisement. In this instance, a Hyundai Card web site perfectly corresponding to the keyword of ‘HYUNDAI CARD’ is exposed in the web page 230 of the search site as the top priority. Specifically, the Hyundai Card web site is positioned at a top portion of the web page where attention of the user is most attracted.

FIG. 3 is a diagram illustrating an example of a process where banner advertisement is exposed on a banner advertisement window in the method for offering banner advertisement with a search function according to an exemplary embodiment of the present invention.

Referring to FIG. 3, in operation S301, whether guaranteed banner advertisement is exposed in the banner advertisement window is determined. In this instance, the guaranteed banner advertisement is banner advertisement commercialized as a form of Cost Per Mill (CPM). CPM denotes an advertising flat rate which is paid for advertisement exposures of 1,000 times. In this regard, when it is assumed that CPM is 100 won, the advertising rate paid for advertisement exposures of 1,000 times is 100 won. However, the guaranteed banner advertisement may be banner advertisement commercialized as another form other than CPM.

When the guaranteed banner advertisement does not exist according to the determination result, an advertisement managing system 400 commands an advertisement transmission server 410 to expose a default advertisement. Then, the advertisement transmission server 410 exposes the default advertisement in the banner advertisement window in operation S302.

Conversely, when the guaranteed banner advertisement exists according to the determination result, the advertisement managing system 400 commands the advertisement transmission server 410 to expose the guaranteed banner advertisement. Then, the advertisement transmission server 410 loads the search input window having a search function and the banner advertisement to the banner advertisement window to thereby connect the search input window with the banner advertisement in operation S303, and the banner advertisement window where the banner advertisement and the search input window are connected with each other is registered in a server template as a template, and a template of a corresponding banner advertisement is selected in operation S304. In this instance, the banner advertisement and the search input window may be a flash animation made by a flash creating program.

Next, an advertisement transmission tag and an exposure tag are transmitted to a client template in operation S305, so that the banner advertisement window where the banner advertisement and the search input window are connected with each other is exposed in the site providing the banner advertisement in operation S306.

The method for offering banner advertisement with a search function according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

### BRIEF DESCRIPTION OF DRAWINGS

FIG. 1 is a flowchart illustrating a method for offering banner advertisement with a search function according to an exemplary embodiment of the present invention;

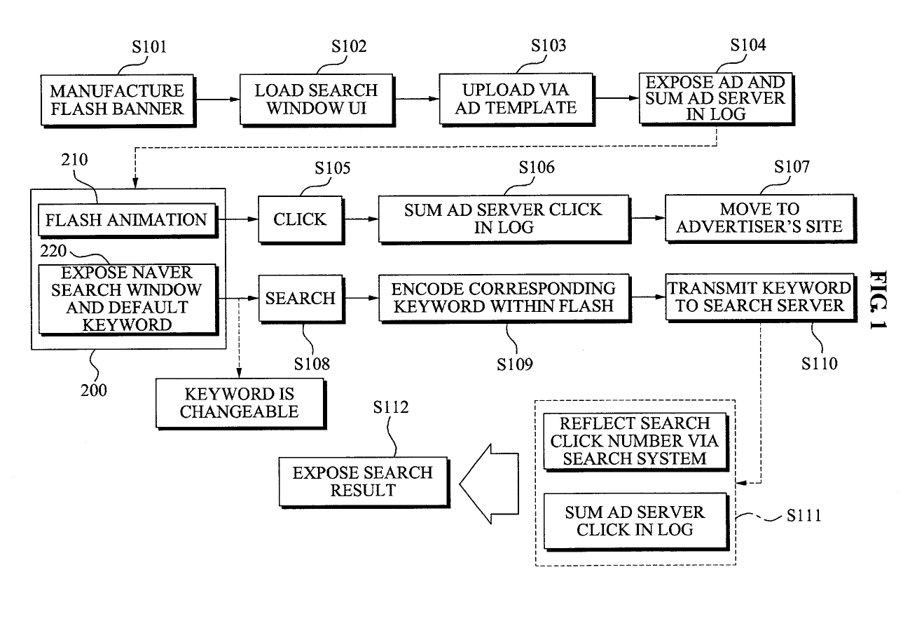

FIG. 2 is a diagram illustrating an example of a search result screen acquired by performing a search via a search input window in the method for offering banner advertisement with a search function according to an exemplary embodiment of the present invention;

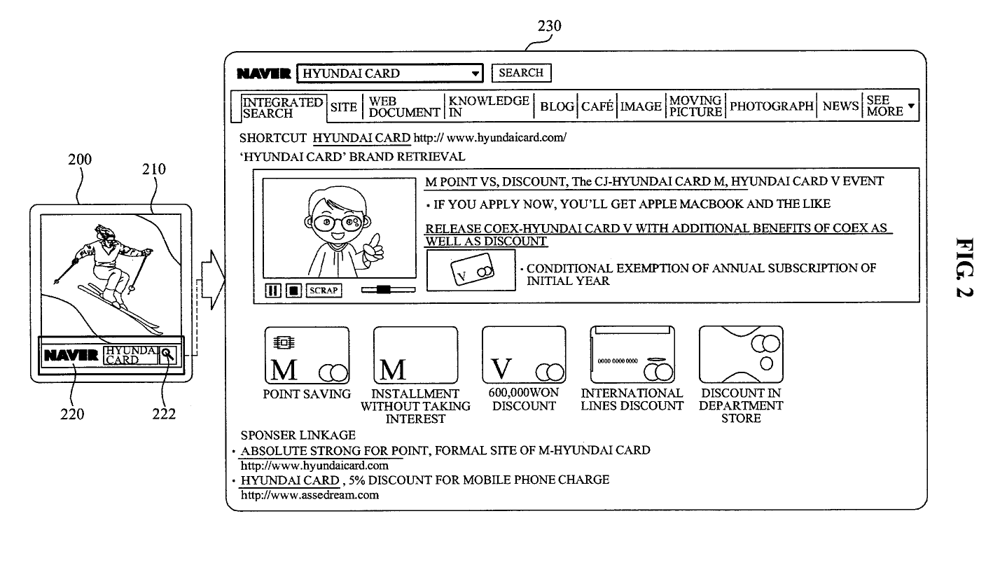

FIG. 3 is a diagram illustrating an example of a process where banner advertisement is exposed on a banner advertisement window in the method for offering banner advertisement with a search function according to an exemplary embodiment of the present invention;

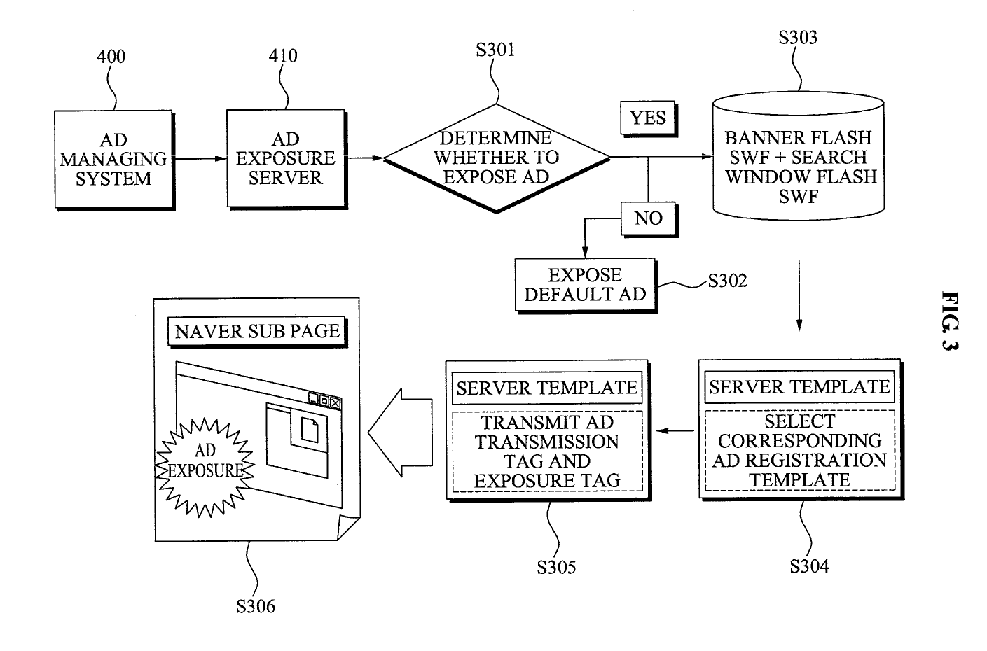

FIG. 4 is a schematic diagram illustrating a system for offering banner advertisement with a search function according to an exemplary embodiment of the present invention;

FIG. 5 is a configuration block diagram illustrating a configuration of an advertisement exposure server of a system for offering banner advertisement with a search function according to an exemplary embodiment of the present invention, in detail; and

FIG. 6 is a configuration block diagram illustrating a log processing system of a system for offering banner advertisement with a search function according to an exemplary embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. For reference, a module directly or indirectly related to the present invention is mainly illustrated in drawings. However, blocks illustrated in the present invention may be designed as a module, and the module denotes one unit for processing a specific function or operation. Also, the module may be implemented in hardware or software, or any combination thereof.

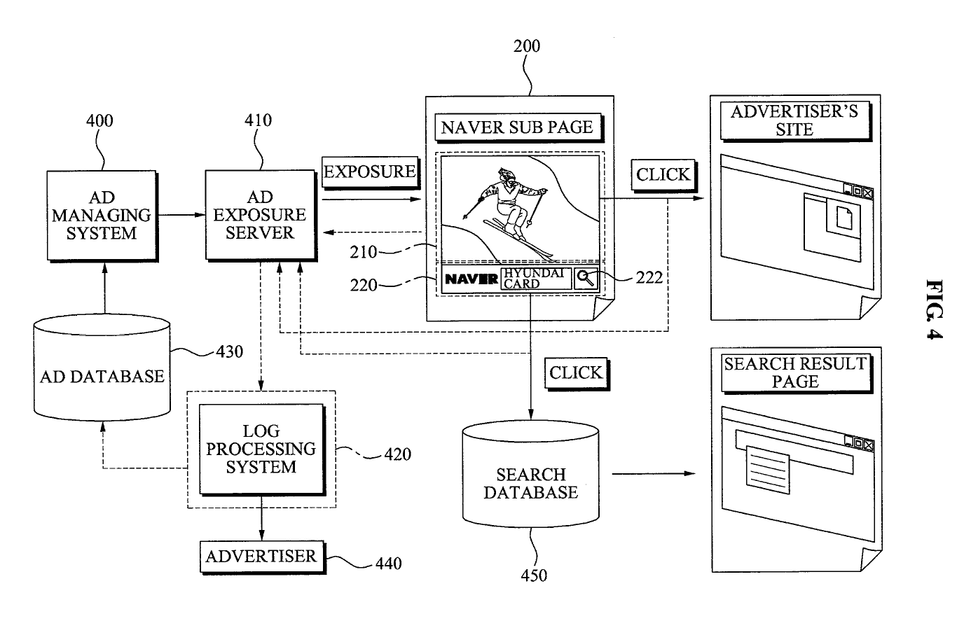

FIG. 4 is a schematic diagram illustrating a system for offering banner advertisement with a search function according to an exemplary embodiment of the present invention. According to the present exemplary embodiment of the invention, a log processing system 420 is provided separate from an advertisement exposure server 410, and the advertisement exposure server 410 may include the log processing system 420.

Referring to FIG. 4, an advertisement managing system 400 commands the advertisement exposure server 410 to expose an advertisement. Then, the advertisement exposure server 410 exposes, in a site providing the banner advertisement, the banner advertisement window 200 where a search input window 220 and the banner advertisement 210 are connected with each other according to the advertisement exposure command from the advertisement managing system 400.

In this instance, the advertisement exposure server 410 transmits, to the log processing system 420, a number of times the banner advertisement window 200 is exposed in the site providing the banner advertisement. Then, the log processing system 420 sums the number of exposures transmitted from the advertisement exposure server 410 in a log, and records the summed number of exposures in an advertisement database 430.

Also, when a user clicks on the banner advertisement 210 in the banner advertisement window 200 exposed in the site providing the banner advertisement using a mouse pointer, the advertisement exposure server 410 exposes an advertiser's site of the clicked banner advertisement 210 via either the web page where the banner advertisement 210 is exposed or a separate web page. However, the advertisement exposure server 410 may expose the banner advertisement 210 in the banner advertisement window 200 other than the above-described web pages.

In this instance, the advertisement exposure server 410 transmits, to the log processing system 420, a number of times the banner advertisement 210 is clicked on. Then, the log processing system 420 sums the number of clicks of the banner advertisement 210 transmitted from the advertisement exposure server 410 in a log, and then the summed number of clicks of the banner advertisement 210 is recorded in the advertisement database 430. Also, the log processing system 420 provides, to an advertiser 440, the summed number of clicks of the banner advertisement in a form of a report.

Also, in the case where a search is performed through the search input window 220 by a user, when a keyword is inputted in the search input window 220 in the advertisement exposure server 410 and the search execution button 222 is clicked on, information associated with the keyword is retrieved in the search database 450, and the retrieval results are exposed in a web page via the site providing the banner advertisement or a search site of a search server.

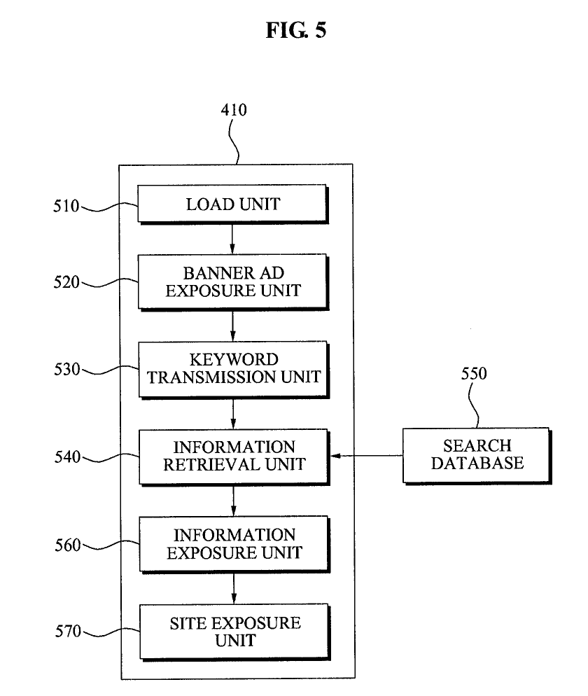

FIG. 5 is a configuration block diagram illustrating a configuration of an advertisement exposure server of a system for offering banner advertisement with a search function according to an exemplary embodiment of the present invention, in detail.

Referring to FIG. 5, the advertisement exposure server 410 includes a load unit 510, a banner advertisement exposure unit 520, a keyword transmission unit 530, an information retrieval unit 540, an information exposure unit 560, and a site exposure unit 570.

The load unit 510 loads the search input window with a search function to a predetermined area of the banner advertisement window. In this instance, the load unit 510 is preferably provided such that a User Interface (UI) of the search site providing a search function is loaded to the banner advertisement window.

When the search input window is loaded to the banner advertisement window, the load unit 510 provides, in the search input window, a keyword associated with the banner advertisement displayed on the banner advertisement window as a default value. Also, when the search input window is loaded to the banner advertisement window, the load unit 510 may provide or may not provide, in the search input window, a keyword unassociated with the banner advertisement displayed on the banner advertisement window.

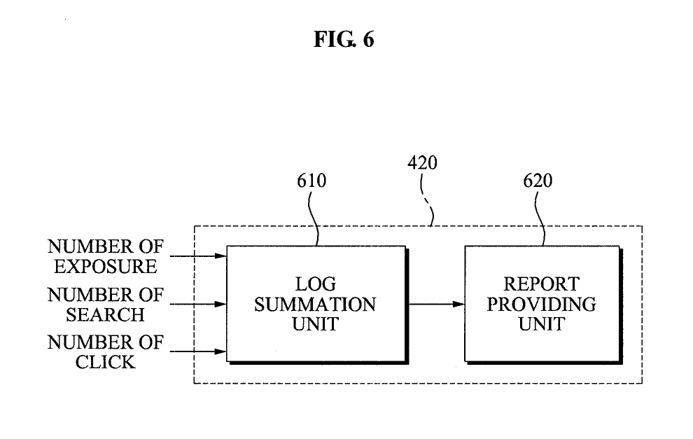

The banner advertisement exposure unit 520 exposes the search input window loaded by the load unit 510 in the banner advertisement window including the banner advertisement. In this instance, the search input window may be provided with the search execution button 222. Also, the banner advertisement may be flash advertisement made by a flash creating program. The flash banner advertisement may encode the keyword inputted when a keyword is inputted in the search input window, and transmit the inputted keyword to the search server (not shown). The banner advertisement exposure unit 520 may calculate a number of times the banner advertisement is exposed, and transmit the calculated number to a log summation unit (see FIG. 6) of the log processing system.

The keyword transmission unit 530 encodes the inputted keyword and then transmits the encoded keyword to the search server, when a search is performed with respect to the keyword inputted in the search input window. In this instance, the keyword inputted in the search input window may be encoded within the above-described flash banner advertisement.

The information retrieval unit 540 retrieves, from a search database 550, information associated with the keyword transmitted from the retrieval transmission unit 530. When the information associated with the keyword is retrieved from the search database 550, the information retrieval unit 540 arranges the retrieved information according to the priority of the information and transmits the arranged information to the information exposure unit 560. Conversely, when the information associated with the keyword is not retrieved in the search database 550, the information retrieval unit 540 transmits, to the information exposure unit 560, a message indicating information associated with the keyword does not exist. The information retrieval unit 540 may calculate a number of times a search is performed with respect to the keyword, and then transmit the calculated number to the log summation unit (see FIG. 6) of the log processing system.

The information exposure unit 560 exposes retrieval results performed in the search database 550 by the information retrieval unit 540. Specifically, when information associated with the keyword is retrieved in the information retrieval unit 540, the information exposure unit 560 exposes retrieval information, which is aligned according to the priority, as the retrieval results. Conversely, when the information associated with the keyword is not retrieved in the information retrieval unit 540, the information exposure unit 560 receives, from the information retrieval unit 540, a message indicating information associated with the keyword does not exist, and does not expose any retrieval results.

In this instance, preferably, the information exposure unit 560 may expose the retrieval results retrieved from the search database 550 in the site providing the banner advertisement, or in the search site of the search server.

The site exposure unit 570 exposes an advertiser's site of the banner advertisement when the banner advertisement is clicked on by a mouse pointer, and the like. The site exposure unit 570 may transmit, to the log summation unit (see FIG. 6) of the log processing system, a number of times the banner advertisement is clicked on by the mouse pointer and the like.

FIG. 6 is a configuration block diagram illustrating a log processing system of a system for offering banner advertisement with a search function according to an exemplary embodiment of the present invention.

Referring to FIG. 6, the log processing system 420 includes a log summation unit 610, and a report providing unit 620.

The log summation unit 610 sums a number of exposures of the banner advertisement, a number of times of the search execution, and a number of clicks of the banner advertisement in a log. Specifically, the log summation unit 610 sums the number of exposures of the banner advertisement, the number of times of the search execution, and the number of clicks of the banner advertisement in the log from the banner advertisement exposure unit 520, the information retrieval unit 540, and the site exposure unit 570 illustrated in FIG. 5, respectively.

The report providing unit 620 provides the number of exposures of the banner advertisement, the number of times of the search execution, and the number of clicks of the banner advertisement summed in the log summation unit 610, respectively, alone or in a separate form of a report.

The method for offering banner advertisement with the search function according to the present exemplary embodiment of the invention includes at least one of the below effects.

First, the search input window is connected with the banner advertisement, so that the search function and the banner advertisement function can be simultaneously embodied, thereby maximizing advertising effect.

Second, the number of exposures of the banner advertisement and the number of clicks of the banner advertisement are summed in a log to thereby be provided to the advertiser in a form of a report, and thus calculating guarantee with respect to the banner advertisement.

Third, the number of times the search is performed through the search input window is summed in a log to thereby be provided to the search site, and thus reflecting the summed number in the number of the search queries of a corresponding keyword.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1-19. (canceled)

20. A computer-implemented method for offering banner advertisement with a search function, the method comprising the steps of:
providing a first window frame for location of a search query interface, the search query interface allowing users to input a search query through the search query interface;
providing said first window frame positioned in association with a second window frame for banner advertising wherein a banner advertisement is displayed within the second window frame; and
upon receipt of a search request with a search query including at least one search keyword from a user through said search query interface, providing the user with a search result,
wherein the steps of providing a first window frame and of providing said first window frame are performed by one or more processors.

21. The method of claim 20, wherein said first window frame is positioned adjacent said second window frame.

22. The method of claim 20, wherein said first window frame is attached to said second window frame.

23. The method of claim 20, wherein said first window frame is positioned within said second window frame.

24. The method of claim 20, further comprising the step of displaying a default search keyword in said first window frame to indicate the search query interface.

25. The method of claim 20, wherein the banner advertisement includes a flash banner advertisement, and the keyword inputted through said search query interface is encoded within the flash banner advertisement.

26. The method of claim 20, wherein the search result is displayed on a web page that includes said banner advertisement.

27. The method of claim 20, wherein said search query received from the user is transmitted to a search server over a network and the search result is displayed on a web page operated by the search server.

28. The method of claim 20, further comprising the steps of:
counting a number of search requests received through said search query interface; and
providing the counted number of search requests.

29. The method of claim 20, further comprising the steps of:
exposing an advertiser's web site associated with the banner advertisement when the banner advertisement is clicked on;
counting a number of clicks on the banner advertisement; and
providing the counted number of clicks on the banner advertisement.

30. One or more storage media having stored thereon a computer program that, when executed by one or more processors, causes the one or more processors to perform acts including:
providing a first window frame for location of a search query interface, the search query interface allowing users to input a search query through the search query interface;
providing said first window frame positioned in association with a second window frame for banner advertising wherein a banner advertisement is displayed within the second window frame; and
upon receipt of a search request with a search query including at least one search keyword from a user through said search query interface, providing the user with a search result.

31. A system for offering banner advertisement with a search function, the system comprising:
an advertisement exposure server linked with a target web page over a network, the advertisement exposure server comprising:
a processor;
one or more memories communicating to said processor;
a load unit for providing a first window frame for location of a search query interface, the search query interface allowing users to input a search query through the search query interface;
a banner advertisement exposure unit for exposing said first window frame positioned in association with a second window frame for banner advertising wherein a banner advertisement is displayed within the second window frame; and
a keyword transmission unit for transmitting a search query including at least one search keyword from a user through said search query interface.

32. The method of claim 31, wherein said first window frame is positioned adjacent said second window frame.

33. The method of claim 31, wherein said first window frame is attached to said second window frame.

34. The method of claim 31, wherein said first window frame is positioned within said second window frame.

35. The system of claim 31, wherein the load unit provides a User Interface (UI) of a search site providing the search function in the banner advertising window.

36. The system of claim 31, wherein the load unit displays a default search keyword in said first window frame to indicate the search query interface.

37. The system of claim 31, the banner advertisement exposure unit further comprises:
an information retrieval unit for generating a search result in responsive to the search request; and
an information exposure unit for providing the search result.

38. The system of claim 31, wherein the banner advertisement includes a flash banner advertisement, and the keyword inputted through said search query interface is encoded within the flash banner advertisement.

39. The system of claim 31, wherein the advertisement exposure server further comprises a site exposure unit for exposing an advertiser's web site associated with the banner advertisement when the banner advertisement is clicked on.
